(19) United States
(12) Patent Application Publication
(10) Pub. No.: US 2012/0225976 A1
(43) Pub. Date: Sep. 6, 2012

(54) Composition of thermoplastic composites, manufacturing processes and resulting products

(75) Inventor: Guilherme Hoffmann Bampi, Manaus (BR)

(73) Assignee: Madeplast Indústria e Comércio de Madeira Plástica LTDA-ME

(21) Appl. No.: 13/410,565

(22) Filed: Mar. 2, 2012

(30) Foreign Application Priority Data
Mar. 4, 2011 (BR) PI1101225-0

(51) Int. Cl. C08L 97/02; B29C 45/00

(52) U.S. Cl. 524/13; 264/328.1

(57) ABSTRACT

Composition of thermoplastic composites, manufacturing process and resulting products refers to thermoplastic composites, manufacturing processes and the resulting products applied in the wood plastic composites industry (WPC), for example, by optimizations in composition, in manufacturing and in resulting products, obtaining products for use as structure and/or finishing with excellent physical and chemical characteristics, bringing improvement advantages in the fiber-matrix adhesion, improvement in mechanical properties, reduced water absorption decreasing the use of protective additives against fungi and pests and decreasing the cost of raw materials.

### RELATED APPLICATIONS

This nonprovisional patent application claims priority to and the benefit of the filing date of BR PI1101225-0, which was filed on Mar. 4, 2011 as an application for a patent of invention (PI) in Brazil by Applicant Madeplast Indústria e Comércio de Madeira Plastica LTDA—ME with inventor Guilherme Hoffmann Bampi. The application BR PI1101225-0 is incorporated by reference herein.

### BACKGROUND OF INVENTION

The present invention relates to thermoplastic composite optimizations, manufacturing process and the resulting products applied in the wood plastic composites industry (WPC), which can obtain pellets and extruded parts with excellent physical and chemical characteristics for application as structure and/or finishing, bringing improvement advantages in the fiber-matrix adhesion, improvement in mechanical properties, reduced water absorption decreasing the use of protective additives against fungi and pests and decreasing the cost of raw materials.

The processing industry, particularly the wood plastic composites industry, provides a variety of plastic products which come with continuous improvement, presenting appropriate characteristics for the replacement of many materials traditionally used in the production of goods and products. Materials such as wood, for example, can already be replaced with great acceptance by a series of composite materials widely spread.

Composite materials are defined as materials consisting of two or more components, for example, with different compositions, structures and properties, which may be separated by an interface. A main objective in producing composites is to combine different materials to produce a single product with superior properties to those of the unitary components. Thus, composites with optical, structural, electrical, optoelectronics, chemical and other purposes are easily found in modern devices and systems (see, e.g., Laboratory of Polymer Engineering and Composites of UFMG—[Federal University of Minas Gerais]—http://www.demet.ufmg.br/docentes/rodrigo/compositos.htm).

Thus it is possible to design a material keeping in mind its need of use, i.e., if it is desired to obtain a composite product having the characteristics of structural strength and thermal-acoustic insulation, it is possible then to combine materials that together in a composite product present such features.

An important point with regards to composite materials is that they allow to aggregate materials generated from the disposal of other industrial processes, for example, waste from sawmills, can be reconducted to a production process in the form of fillers; discarded paper and cardboard can be turned into pulp again and molded in the form of other products ranging from modular structures to furniture to providing fibers for structural composite panels. Therefore, an important consideration of composite material is often recycling.

Information related to the technological field of composites can be found in various domestic and international patents, namely:

The Brazilian patent document PI0103601-7 entitled “COMPOSITION OF COMPOSITE OF FIBROUS AND THERMOPLASTIC WASTE MATERIAL,” which relates to a composition of the composite material obtained from fibrous and thermoplastic lignocellulosic waste materials, which admit different geometries and dimensions with particular application in the furniture and construction industries. The composite takes advantage of the rigidity and resistance of the fibrous particulate fillers from sawdust by the dispersion in the resin matrix which acts as a binder and transfers forces from one fiber to another. The optimum proportions of the constituents may vary, of course, according to the characteristics of raw materials, the shape and geometry of the desired final product as well as its physical and mechanical properties, and its extreme limits are as follows:—wood fibers 30-80%—thermoplastic granules 20 to 70%. The constituents of the composition should have the following particle sizes:—wood fibers from 0.01 to 4 mm—thermoplastic granules from 0.5 to 10 mm.

The foregoing technology uses neither a coupling agent nor additives and does not achieve functionalization of the fibers, and it is manufactured by injection molding or extrusion.

The Brazilian patent document PI 0103654-8 entitled “PROCEDURE FOR OBTAINING COMPOSITE PLASTIC, REINFORCED WITH WASTE PLANT AND/OR FLAME RESISTANT SYNTHETIC FIBERS, RESULTING PRODUCTS AND USES OF PRODUCTS,” is characterized by obtaining the thermoplastic matrix composites consisting of polyolefin, recycled or not, reinforced with natural fibers and/or synthetic additives with inorganic constituents, containing aluminum, phosphorus, magnesium, titanium and others, as well as antioxidants, in order to obtain materials with a low burning rate, resistant to ultraviolet rays and with good mechanical properties that enable their use in substitution of wood, in its various structural uses; the process consisting of several consecutive stages of temperature-controlled mixture not exceeding the degradation of each component alone, in the extruder or the like, followed by injection molding into the desired moldings.

The foregoing technology does not involve an end product extrusion, uses no coupling agents, does not obtain the functionalization of the fibers, and only aims at cost reduction.

The Brazilian patent document PI0402485-0 entitled “COMPOSITE CONTAINING VEGETABLE FIBERS, INDUSTRIAL WASTE AND MINERAL FILLERS AND MANUFACTURING PROCESS” describes a composite containing vegetable fibers, industrial wastes and mineral fillers associated with a thermoplastic resin, providing a high strength material. Further, it relates to a process for making a composite comprising the steps of crushing or grinding the vegetable fibers of industrial wastes, the mixture of thermoplastic resins, introducing the mixture into the intrusion machine at a temperature between 80 and 300° C. and forming the mixture into a chamber at a pressure between 05 to 1500 kg/cm².

The foregoing technology does not make continuous extrusion profiles, it uses no coupling agents, it does not obtain the functionalization of the fibers, and it only aims at cost reduction.

The patent document U.S. Pat. No. 5,516,472 entitled “Extruded synthetic wood composition and method,” describes an apparatus and a process for combining an organic fibrous material with a thermoplastic material forming a wood imitation composite. The mixed material is extruded into a die system consisting of a transition die, a stranding die and a molding die. The flow rate of material through the molding system is equalized by the execution of the material mixed with the transition die into a shape approaching the final product, stranding the material with the stranding die to form individual strands, and to compress the individual strands forming the die after it exits the stranding die. The die system may also include an adapter die positioned between the extruder and the transition die which functions to control the amount of mixed material that enters the die system. A product consisting of mixed recyclable materials and chopped to form a wood imitation composite from a low temperature extruder is also provided.

The technology of the foregoing patent only shows equipment and process of mixing, extruding and cooling, it does not allow for the obtaining of pellets for use in other processes, for example, injection of parts.

The patent document U.S. Pat. No. 6,210,616 entitled “Thermoplastic composite profile extrusion with high filler content,” describes an extrusion process and an apparatus, which is disclosed for the compounding of thermoplastic containing a filler product having a desired resin-filler mixture consisting of 60-20% by weight of a thermoplastic resin and 40-80% by weight of a filler. A resin-filler mixture, in homogeneous form, is extruded through a die at a temperature above the softening point of the resin to form an extrudate having a desired cross-sectional shape. The extrudate is then passed through a die land at a temperature of above the softening point. From the die land the extrudate is cooled in a cooled shaper and transferred through the same thermal barrier insert member, which is disposed in contact between the die land and the cooled shaper whereby radial pressure to counteract radial expansion tendencies of the extrudate is maintained during the passage. The cooler shaper cools the extruded to a temperature of at least 20° C. below the softening point of the resin. A lubricant is applied to the exterior surface of the extrudate prior to feeding the extrudate to the cooled shaper.

The technology of the aforementioned patent only shows equipment and process of mixing, extruding and cooling, it does not allow the obtaining of pellets for use in other processes, for example injection of parts.

The patent document U.S. Pat. No. 6,479,002 entitled “Extrusion plant materials encapsulated in a thermoplastic material,” provides for a method and an apparatus for the production of shaped articles or moldings, with which predominantly includes plant material and a thermoplastic material and which are both introduced into an extruder. The plant material is compacted under pressure in a first extruder section, and together with the thermoplastic material they are heated to a defined temperature so that the thermoplastic material melts. The pressure is then to a value in which the residual moisture of the heated material is transformed into water vapor or steam, which is removed from the extruder. The material is then heated, dehumidified, compressed and extruded to the desired molding.

The technology described in the aforementioned patent uses cheaper mineral filler without the use of a coupling agent, it does not obtain functionalization of fibers and it aims at cost reduction.

The patent document US2010319144 refers to structural composite material having a weft section positioned along a horizontal axis and at least one flange section disposed along the horizontal axis, parallel and integrally molded so as to fit into a top surface or bottom of the weft section in which the composite is formed by a mixture of (A) high density polyethylene, (B) fiber material coated with thermoplastic material, polystyrene or a combination of these materials.

The US document, above-mentioned, is illustrative of the composite technique in which a material can be produced based on the demand to which it is intended for, in this case the construction, however, in the said document there are not provisions for introducing waste material of another production process, for example, from the plastics processing industry

The patent document EP2216365 refers to the use of waste materials in the production of other composite materials usable within the current techniques of extrusion and molding, thus generating “green” products and with features comparable to existing materials.

The EP patent document mentioned above is illustrative of the use of waste materials for use in the production of new composite materials, useful and regarded as “green” products, i.e., that contribute to reducing environmental damage. Basically, the EP document describes how to produce composite materials from recycling cardboard paper via a technique limited to paper/cardboard products.

The patent document CN101698750 refers to a wood plastic material which is characterized by a low-weight composite material consisting of a mixture of an inorganic filler, an organic filler, a thermoplastic resin, a terminal amino polyhydric alcohol ester composite modifier and a hydrocarbon mixture of fatty and resin weight ratio of components is 5-30 parts of inorganic filler, 20-80 parts organic fillers, 20-50 parts of thermoplastic resin, 3-5 parts of polyhydric alcohol ester composite modifier and 3-6 terminal amine parts of mixture of fatty hydrocarbon resin in which the inorganic filler includes one or more of calcium carbonate, kaolin, talc, ash, glass beads and the organic fillers consist of wood fibers or non-wood plant fibers.

The product described in the above CN document has a high recycle rate and good processing characteristics, however, the characteristics of the finished product are not known, which can be extremely limiting as to scope of a product.

### SUMMARY OF INVENTION

As to composition of thermoplastic composites, manufacturing process and resulting products described herein, various objects have been developed, for example, to overcome current drawbacks, limitations and disadvantages of the compositions, manufacturing processes and products. Presented herein are various examples for optimizations for thermoplastic composites, in the manufacturing process and resulting products, and for obtaining products for use as structure and/or finishing with excellent physical and chemical characteristics such as: high tensile strength, high impact resistance, high flexure strength, low water absorption and a higher hardness. These properties can be achieved by the use of a coupling agent that improves fiber-matrix adhesion, improves the mechanical properties, decreases the absorption of water by reducing the use of protective additives against pests and fungi, thus reducing the cost of raw materials. The coupling agent used in various examples herein can obtain products with physical properties that are not known as having been achieved by other manufacturing processes or compositions.

### BRIEF DESCRIPTION OF THE DRAWINGS

To better understand the present invention, the following figures are attached:

FIG. 1 illustrates a graph comparing the tensile properties (ASTM D638-08) of injection composites of this invention, varying the quantities of the coupling agent; MOR: modulus of rupture, SD: standard deviation;

FIG. 2 illustrates a graph comparing the bending properties (ASTM D790-07) of injection composites of the present invention, varying the quantities of coupling agent, MOR: modulus of rupture, SD: standard deviation;

FIG. 3 illustrates a graph comparing the compression properties (ASTM D6108-09) of the composite of the present invention, varying the quantities of the coupling agent, MOR: modulus of rupture, SD: standard deviation;

FIG. 4 shows a comparative graph of water absorption properties (NBR ABNT 14810-03) of the injection composite of the present invention, varying the quantities of the coupling agent, WA: water absorption, SD: standard deviation;

FIG. 5 illustrates a graph comparing the tensile properties (ASTM D638-08) of different compositions tested in the finished product composites of the present invention;

FIG. 6 illustrates a graph comparing the flexure properties (ASTM D6109-05) of different compositions tested in the finished product composites of the present invention;

FIG. 7 illustrates a graph comparing the compression properties (ASTM D6108-09) of different compositions tested in the finished product composites of the present invention;

FIG. 8 illustrates a graph comparing the properties of Shore D hardness (ASTM D2240-05) of different compositions tested in the finished product composites of the present invention;

FIG. 9 illustrates a graph comparing the density properties (ASTM D6111-09) of different compositions tested of the injection composite of the present invention, and

FIG. 10 illustrates a graph comparing the properties of water absorption (NBR ABNT 14810-03) of different compositions tested in the finished product composites of the present invention.

### DETAILED DESCRIPTION OF THE PREFERRED EMBODIMENT

A thermoplastic composition material described herein can include thermoplastic material, lignocellulosic material, mineral or inorganic fillers, coupling agent and additives.

As to a thermoplastic material, it can be a polyolefin polymer, for example a high density polyethylene or a low density polyethylene or a polypropylene recycled or not (or combinations thereof); lignocellulosic material of vegetable and wood fibers can include, for example, pine and/or eucalyptus wood powders, coconut and/or sisal and/or jute and/or bamboo fibers; mineral fillers, for example talc and/or magnesium silicate and/or calcium and/or magnesium carbonates; as a coupling agent, maleic anhydride grafted onto polyolefin may be provided, as a lubricant, for example, a complex mixture of modified ester of fatty acid may be provided; as a photoprotective agent, for example, an amine-type photostabilizer may be provided; as primary and secondary antioxidants agents, process stabilizers of phosphonite-type combined with blocked phenolic composites, secondary aromatic amines, aromatic sulfur-containing co-stabilizers and metal deactivators may be provided; and as coloring agents (e.g., in a “masterbatch” form), for example, may be provided as organic and inorganic composite pigments. Additionally, a composition may use flame retardant additives, expander agent and desiccant agent, return process (defective recycled parts); among others.

According to the present invention, the addition of a coupling agent in the homogenization state aims to improve the fiber-matrix-interaction-in-polymer-matrix-composites. The coupling agent acts by modifying the nature of the fiber by esterification of cellulose with the polyolefin matrix promoting a connection that was difficult before depending on the nature of the polarity of the components.

In trials, various compositions were studied for best properties, such as flexure and tension and low water absorption in a final product. Table 1 illustrates different compositions studied to investigate the effect of adding a coupling agent.

TABLE 1
Study concerning the effect of varying the proportion of
the coupling agent, using only the four major components

| | | Wood | Mineral | Coupling | | | | Water |
|---|---|---|---|---|---|---|---|---|
| % | PEAD | Flour | Filler | Agent | Traction | Flexion | Length | absorption |
| BL04 | 33.0 | 33.0 | 33.0 | 1.0 | 20.50 | 33.47 | 25.37 | 1.46 |
| BL05 | 32.6 | 32.6 | 32.6 | 2.0 | 27.03 | 34.96 | 29.02 | 0.84 |
| BL06 | 32.3 | 32.3 | 32.3 | 3.0 | 25.89 | 36.54 | 31.83 | 0.95 |
| BL07 | 32.0 | 32.0 | 32.0 | 4.0 | 29.86 | 37.31 | 28.25 | 0.9 |
| BL08 | 31.6 | 31.6 | 31.6 | 5.0 | 26.44 | 35.23 | 24.47 | 1.04 |
| BL09 | 31.3 | 31.3 | 31.3 | 6.0 | | 33.40 | 26.94 | 0.96 |

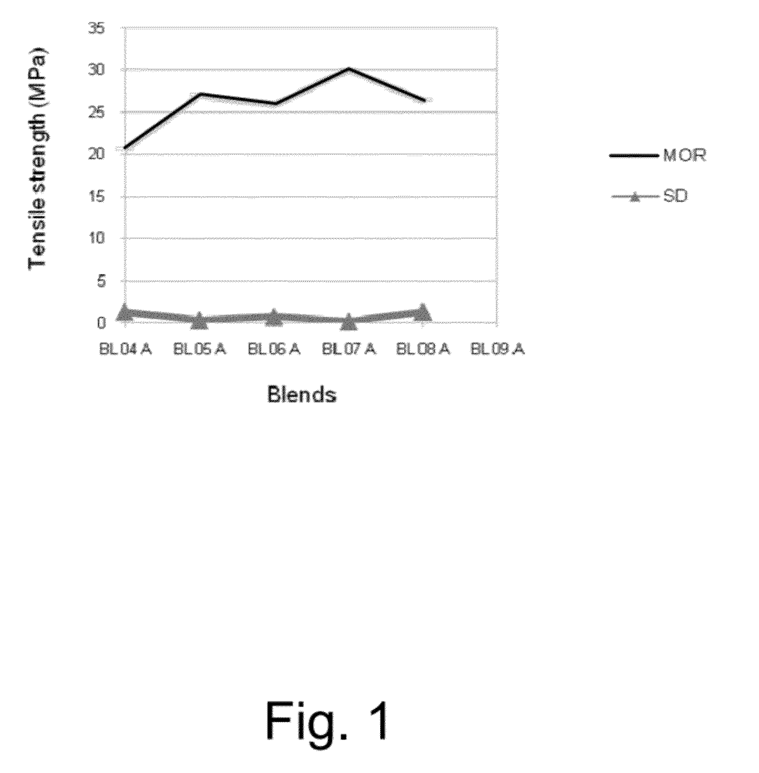

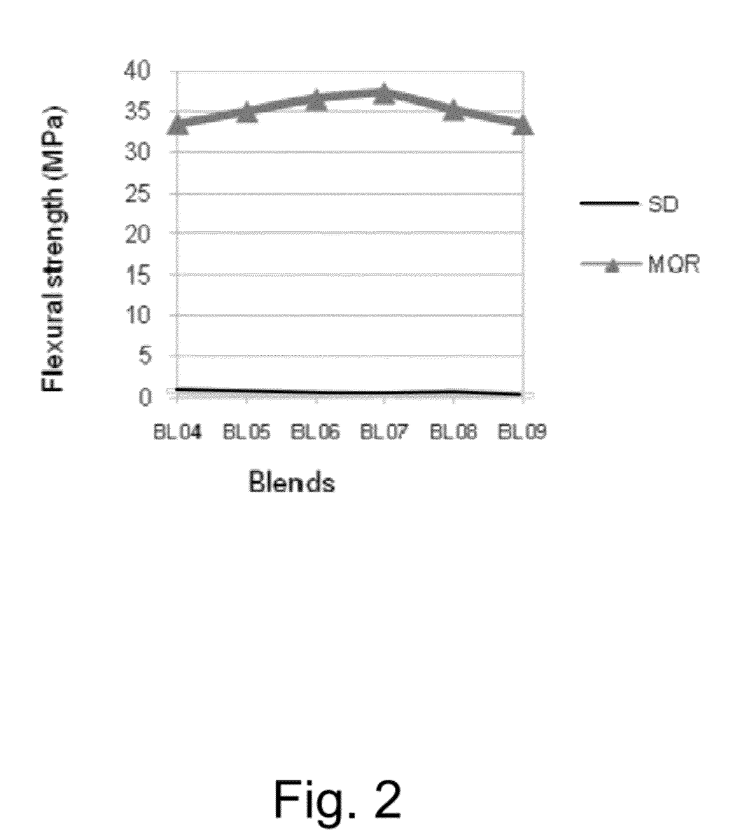

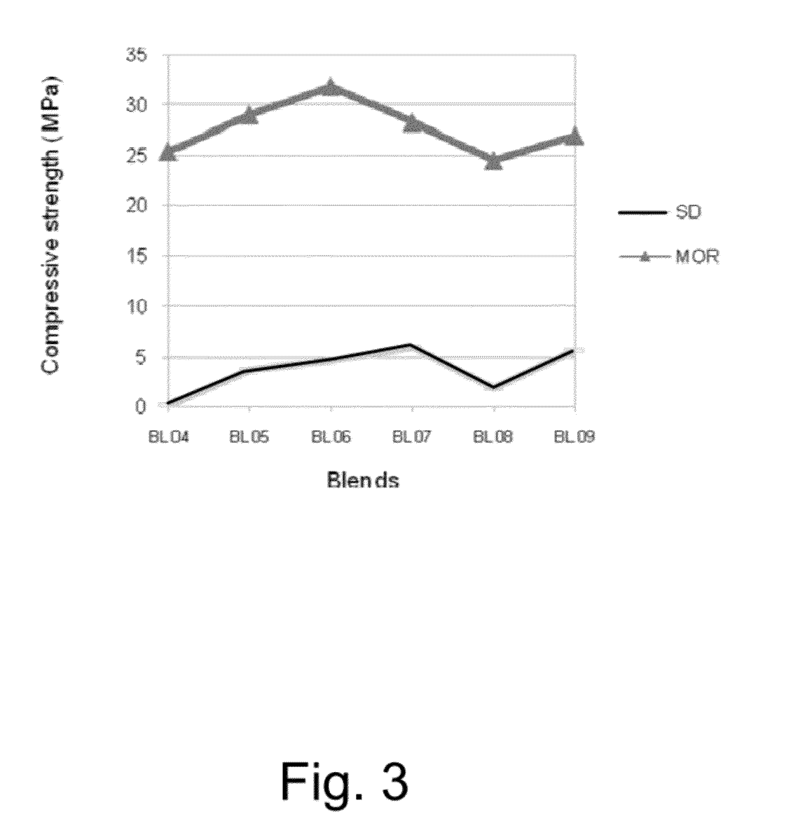

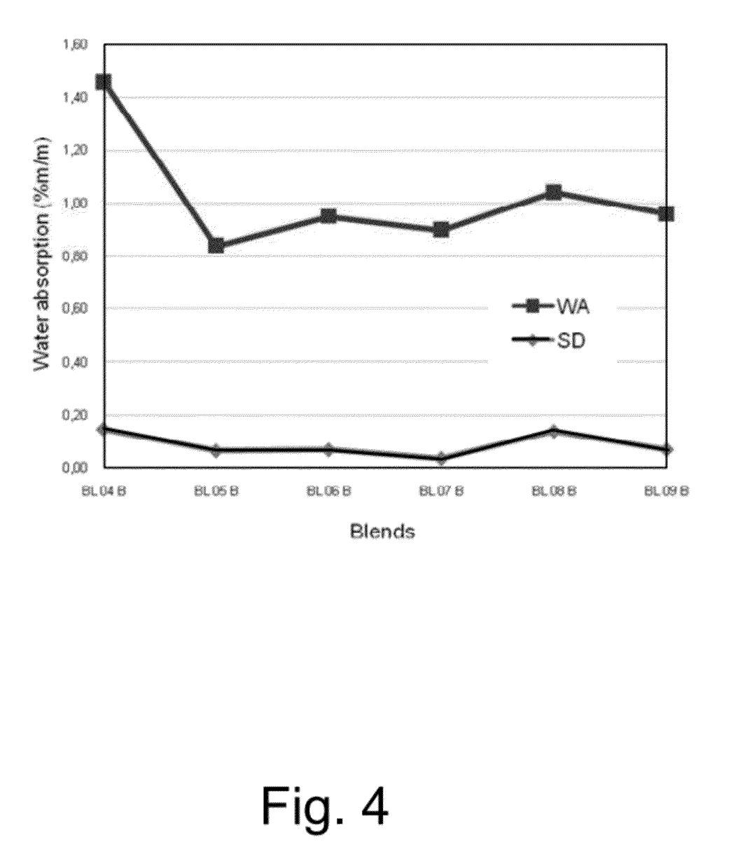

Physical and chemical tests were performed for the development of polymeric composite for determining the characteristics and evaluation of visual and mechanical properties of the final product, and it was concluded that the formulation that gave the best result was the one with 3 to 4% of the coupling agent. FIGS. 1 to 4 show the results of the study to achieve the optimal amount of the coupling agent.

In respect to the tensile strength test, it was observed a slight tendency to increase the values of the Modulus of Elasticity (MOE), which is best evidenced when analyzing the flexure and compressive strength results in which an increase in observed values are compared with results obtained in tests of a mixture in which the coupling agent was not added to.

The same behavior is observed when analyzing the hardness. This magnitude is related to the rigidity properties of the example discussed above. Similarly, the density is directly influenced by the quality of intermolecular bonds.

With regard to impact properties and water absorption, a trend is evident in the Izod impact test: as the proportion of the coupling agent increases, the energy required to break the test sample increases proportionally. And to improve the bonds provided by modifying the polarity of the components, is evidenced by the clear reduction by 85% of water absorption when the material is immersed in water.

The quality of the final product is made through flexure and compressive tests, screw pull, maximum load, a trend to staining, exposure to UV chamber and use of common woodworking tools.

The use of maleic anhydride grafted onto polyethylene in the formulation allows comments in the following items:

Increase in mechanical strength of the final product due to high compatibility caused by the use of maleic anhydride, resulting in quality improvements and increasing the maximum permissible load in the material;

Increased energy required to break the material, a factor that also involves improvements in the quality of the final product to expand its application; and

Increase in water absorption resistance, reducing in this way the required amount of protective additives against attack by pests and fungi, impacting in the lower cost of raw materials.

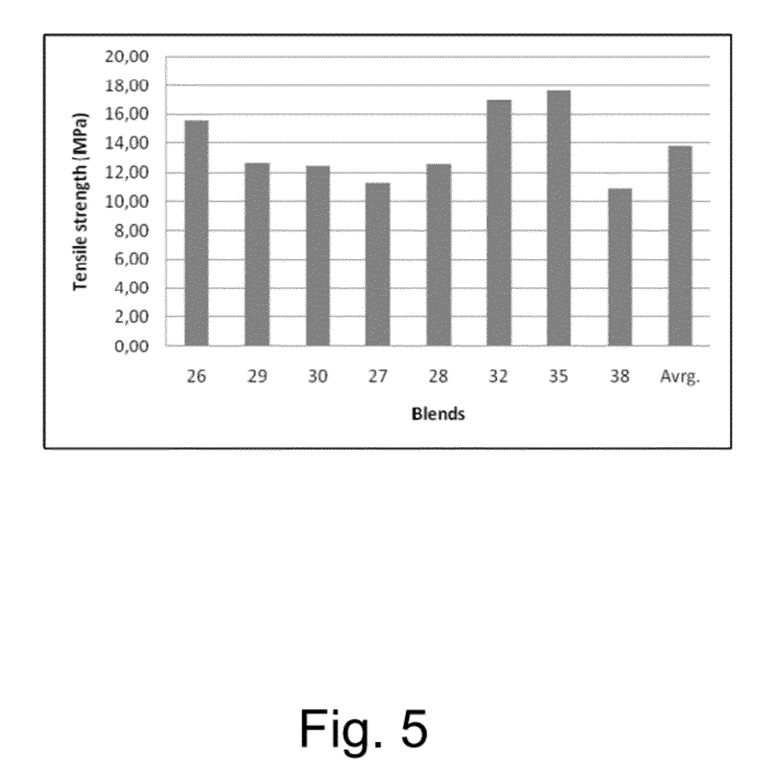

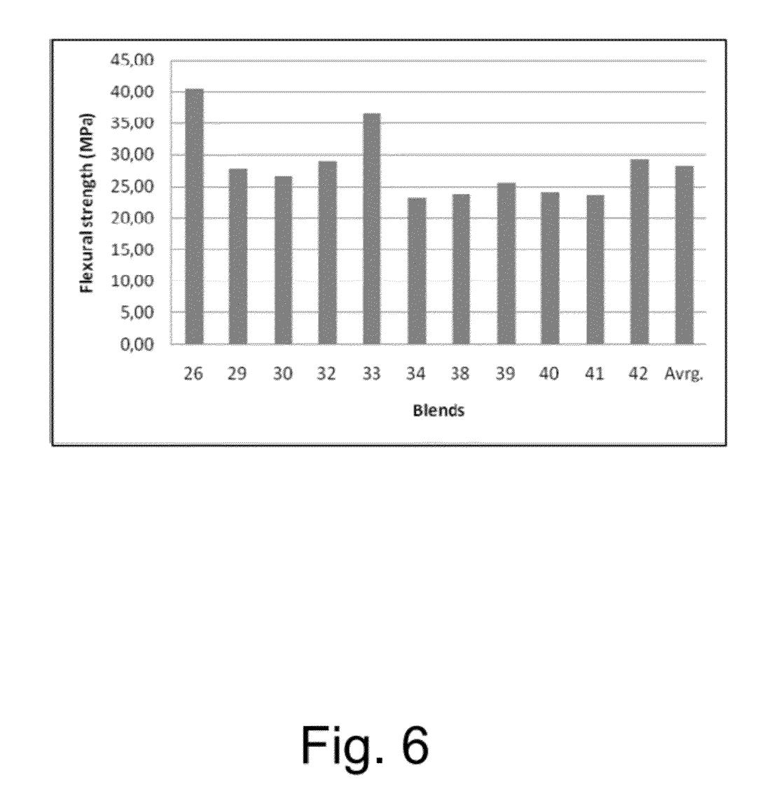

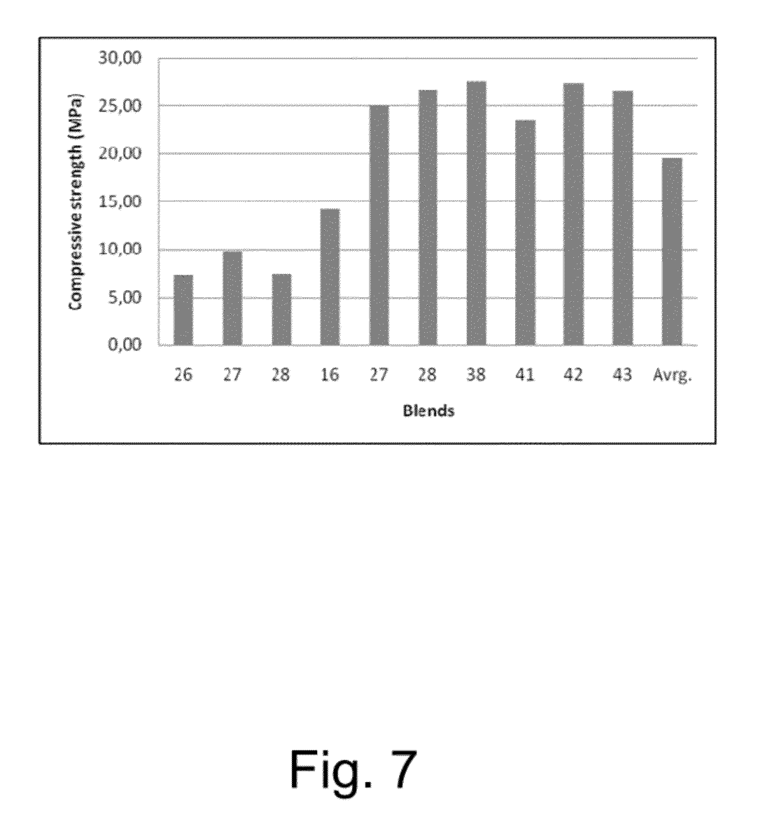

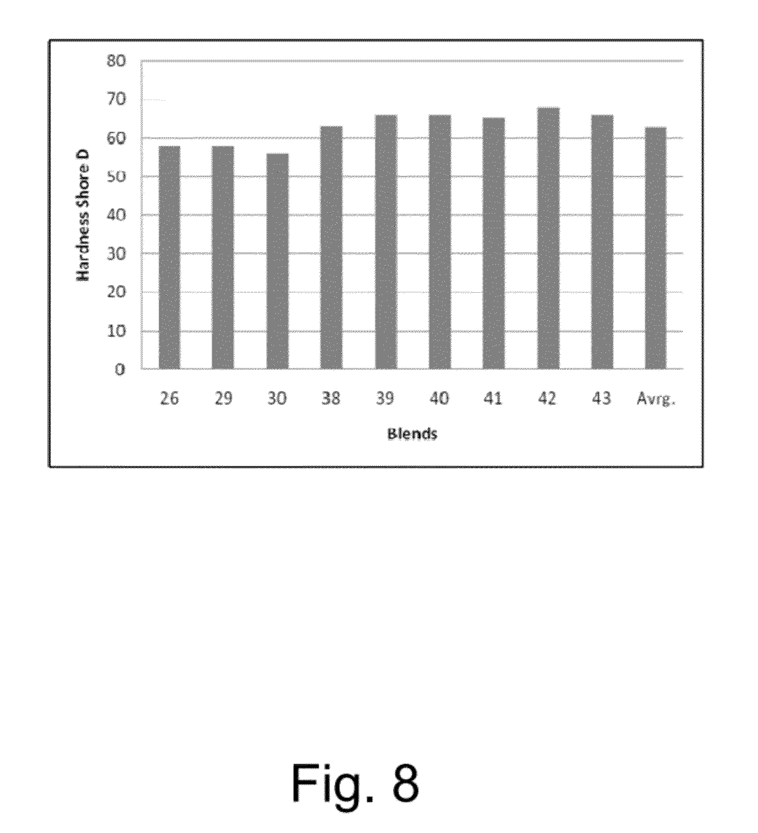

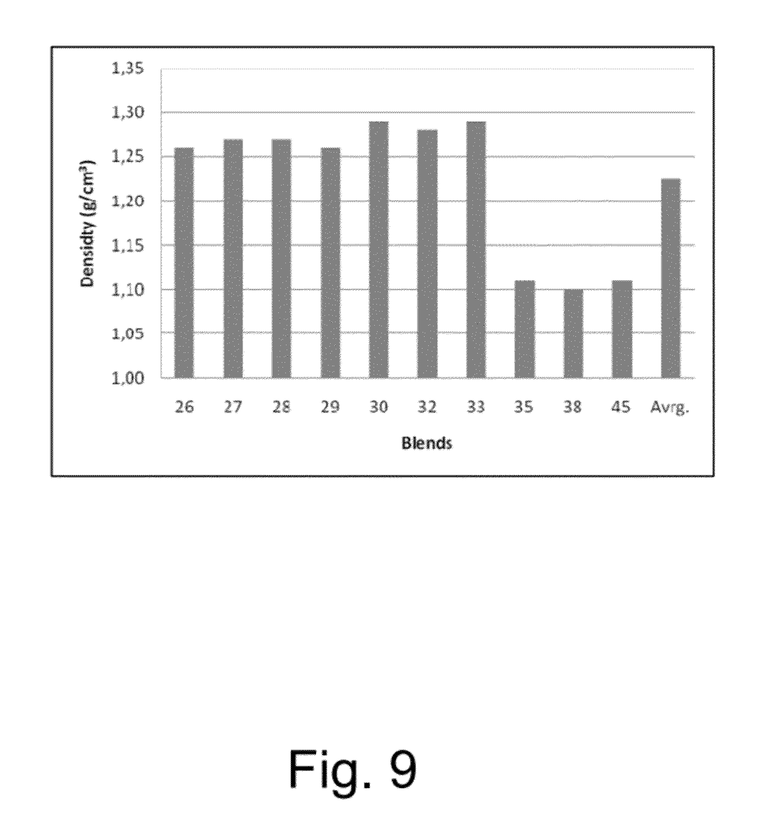

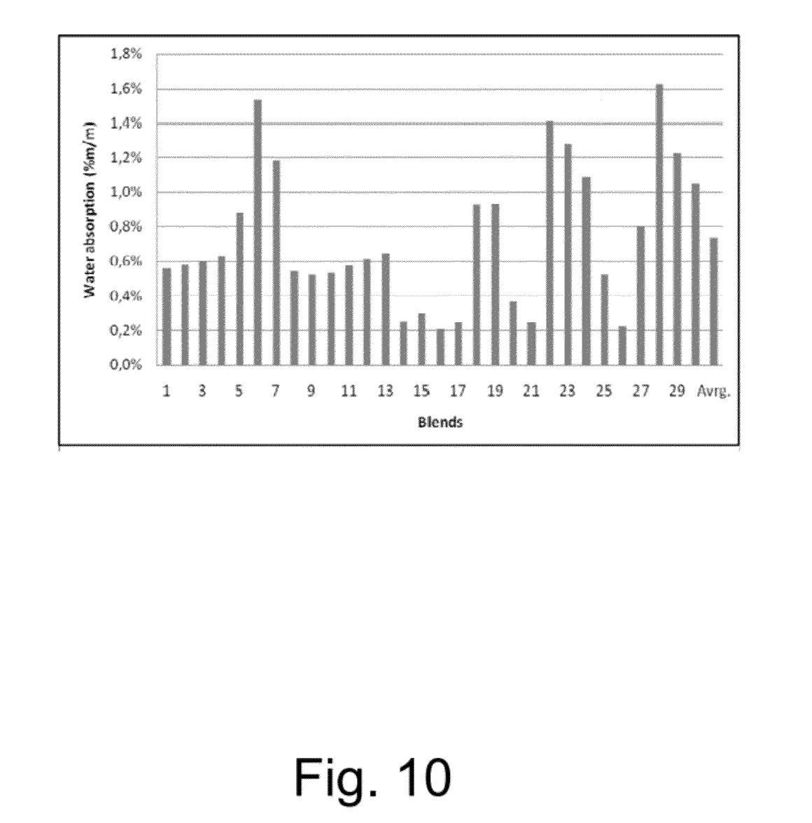

Tests were conducted in accordance with the ASTM and ABNT/NBR Standards, as initially mentioned. The results are shown in the graphs shown in FIGS. 5 to 10.

According to the present invention, as an example, a composition of a thermoplastic material consists, in terms of percentage by weight, a mixture of components as follows:

20 to 50% polyolefin polymer, preferably from high density polyethylene and/or low density polyethylene and/or polypropylene recycled or not;

20 to 50% of lignocellulosic material, preferably pine and/or eucalyptus wood flour and/or coconut and/or sisal and/or jute and/or bamboo fibers;

10 to 40% mineral fillers, preferably talc and/or magnesium silicate and/or calcium and/or magnesium carbonates;

1 to 6% coupling agent, preferably maleic anhydride grafted onto polyethylene;

1 to 7% lubricant, preferably a complex mixture of modified ester of fatty acid;

0.1 to 6% photoprotective agent, preferably amine-type photostabilizer;

0.1 to 5% of antioxidant, preferably the phosphonite type combined with blocked phenolic composites; and

0 to 10% of coloring agent (e.g., as a “masterbatch”) preferably composed of organic and inorganic pigments.

The optimized formulation preferred is:

29.54% polymer recycled high density polyethylene;

29.54% of lignocellulosic material pine wood flour;

29.54% filler mineral talc;

3.68% of coupling agent maleic anhydride grafted onto Polyethylene;

4.00% lubricant mixture of complex mixture of modified ester of fatty acid;

0.50% photoprotective agent amine-type photostabilizer;

0.20% antioxidant phosphonite type combined with phenolic type; and

3.00% titanium dioxide pigment.

According to another aspect of the present invention, an example of a method for obtaining a thermoplastic composite material product is provided, including the following steps:

A) Drying of the lignocellulosic material—the material is dried in a conventional dryer to a moisture content below 2.5%;

B) Homogenization/homogenizing—the composition is mixed by friction until homogenization is reached or a temperature 70 to 110° C. is reached for subsequent cooling;

C) Cooling—the composition is cooled indirectly with water until it reaches a temperature of 50° C.;

D) Granulation—granulating the mixture by extrusion in a twin screw extruder to form pellets; and

E) Extrusion/extruding—After granulation, the material passes through a second extruder which shall form the products, through a die.

The pellets obtained in the granulation (step D) of the manufacturing process can be used in injection molding machines, in the manufacture of various products, and extrusion in the manufacture of plates.

Parts obtained from the optimum composition and process of the present invention, exhibited the following physicochemical characteristics:

Material density: 1.22±0.15 g/cm³;

Water absorption: 0.2 to 2.6%, preferably less than 0.6%;

Linear expansion coefficient: 8×10⁻³ to 1.5×10⁻¹, preferably less than 5×10⁻²;

Shore D hardness (ASTM D2240-05): 50 to 70, preferably less than 65;

Tensile strength (ASTM D638): 5 to 25 MPa, preferably greater than 10 MPa;

Flexure (ASTM D790 and ASTM 6109-05): 7 to 45 MPa, preferably greater than 20 MPa, and

Compression (ASTM D6108-09): 5 to 62 MPa, preferably greater than 10 MPa.

Such characteristics (e.g., material properties) permit the use of products as structural material as well as finishing material.

As described herein, a thermoplastic composite material may be provided in the form of a pellet where such pellet is suitable for extrusion, molding or extrusion and molding. For example, pellets may be fed to an extruder fitted with a die to form one product and fed to an injection molding machine to form another product.

The present invention has been described in terms of its preferred embodiment, however, certain modifications and/or variations will become apparent from the specification presented herein therefore such changes and/or variations are included within the scope presently claimed.

What is claimed is:

1. A thermoplastic composite material characterized by:
material weight percentages for composite components of
20 to 50% polyolefin polymer,
20 to 50% of lignocellulosic material,
10 to 40% mineral fillers,
1 to 6% coupling agent,
1 to 7% lubricant,
0.1 to 6% photoprotective agent,
0.1 to 5% of antioxidant agent, and
0 to 10% of coloring agent; and
material properties of
density in a range of 1.22±0.15 g/cm³,
water absorption in a range of 0.2 to 2.6% and preferably less than 0.6%,
linear expansion coefficient in a range of 8×10⁻³ to 1.5×10⁻¹ and preferably less than 5×10⁻²,
shore D hardness (ASTM D2240-05) in a range of 50 to 70 and preferably less than 65,
tensile strength (ASTM D638) in a range of 5 to 25 MPa and preferably greater than 10 MPa,
flexure (ASTM D790 and ASTM 6109-05) in a range of 7 to 45 MPa and preferably greater than 20 MPa, and
compression (ASTM D6108-09) in a range of 5 to 62 MPa and preferably greater than 10 MPa.

2. The thermoplastic composite material as in claim 1, characterized by:
material weight percentages for composite components of
20 to 50% polyolefin polymer that preferably comprises at least one member selected from a group consisting of high density polyethylenes, low density polyethylenes, recycled polypropylenes and un-recycled polypropylenes;
20 to 50% of lignocellulosic material that preferably comprises at least one member selected from a group consisting of pine wood flours, eucalyptus wood flours, coconut fibers, sisal fibers, jute fibers, and bamboo fibers;
10 to 40% mineral filler that preferably comprises at least one member selected from a group consisting of talc silicates, magnesium silicates, calcium carbonates, and magnesium carbonates;
1 to 6% coupling agent that preferably comprises maleic anhydride grafted onto polyethylene;
1 to 7% lubricant that preferably comprises a complex mixture of modified ester of fatty acid;
0.1 to 6% photoprotective agent that preferably comprises an amine-type photostabilizer;
0.1 to 5% of antioxidant agent that preferably comprises a phosphonite-type antioxidant agent combined with one or more blocked phenolic composites; and
0 to 10% of coloring agent that preferably comprises organic and inorganic pigments.

3. The thermoplastic composite material as in claim 1, characterized by:
material weight percentages for composite components of
29.54% polymer recycled high density polyethylene,
29.54% of lignocellulosic material of wood flour of a pine species,
29.54% filler talc mineral,
3.68% of coupling agent maleic anhydride in polyethylene and graphite,
4.00% lubricant mixture of a complex mixture of modified ester of fatty acid,
0.50% photoprotective agent amine-type photostabilizer,
0.20% antioxidant phosphonite-type combined with phenolic-type, and
3.00% titanium dioxide pigment.

4. A process for production of a thermoplastic composite material as in claim 1, the process characterized by the following steps:
A) drying of lignocellulosic material wherein the lignocellulosic material is dried in a conventional dryer to a moisture content below 2.5%;
B) homogenizing composite components by friction mixing by friction until homogenization is reached or a temperature 70 to 110° C. is reached for subsequent cooling;
C) cooling the homogenized composite components indirectly with water until reaching a temperature of 50° C.;
D) granulating the homogenized composite components by extrusion in a twin screw extruder to form pellets; and
E) extruding the pellets through a die using a second extruder to form the thermoplastic composite material.

5. The process as in claim 4, characterized by, introducing the pellets formed in the granulating step to an injection molding machine to mold a product.

6. The process as in claim 4, characterized by, in the homogenizing step, the coupling agent acts by modifying fiber of lignocellulosic material by esterification of cellulose with a polyolefin matrix.
